(19) United States
(12) Patent Application Publication
(10) Pub. No.: US 2015/0338648 A1
(43) Pub. Date: Nov. 26, 2015

(54) METHODS AND SYSTEMS FOR EFFICIENT RENDERING OF GAME SCREENS FOR MULTI-PLAYER VIDEO GAME

(71) Applicant: SQUARE ENIX HOLDINGS CO., LTD., Tokyo (JP)

(72) Inventor: Alex TAIT, Montreal (CA)

(73) Assignee: SQUARE ENIX HOLDINGS CO., LTD.,, Tokyo (JP)

(21) Appl. No.: 14/363,858

(22) PCT Filed: Jan. 9, 2014
(86) PCT No.: PCT/JP2014/050726

§ 371 Date: Jun. 9, 2014

(51) Int. Cl. G02B 27/01; G06T 15/80; G06K 9/00; G06F 17/30; G06T 11/00; A63F 13/52; A63F 13/213; A63F 13/30; A63F 13/69; A63F 13/87; A63F 13/5375; A63F 13/61; A63F 13/216; A63F 13/792; A63F 13/825; G06T 15/04

(52) U.S. Cl. CPC G02B 27/01; G06T 15/04; G06T 15/80; G06K 9/00771; G06K 9/00369; G06K 9/00201; G06F 17/3025; G06F 17/30262; G06F 17/30256; G06T 11/001; A63F 13/52; A63F 13/213; A63F 13/30; A63F 13/69; A63F 13/87; A63F 13/5375; A63F 13/61; A63F 13/216; A63F 13/792; A63F 13/825; G02B 2027/0138; G06T 2215/12; G06T 2215/16

(57) ABSTRACT

A method for creating and sending video game images comprises identifying a scene being viewed by a participant in a video game; determining whether there exists a previously created image corresponding to the scene and corresponding to a participant category to which the participant belongs. If the determining is positive, the previously created image is retrieved and released towards a device associated with the participant. If the determining is negative, an image is rendered, and the rendered image is released towards the device. Also, there is provided a method for control of video game rendering, which comprises identifying a scene being viewed by a participant in a video game; obtaining an image for the scene; rendering at least one customized image for the participant; and combining the image for the scene and the at least one customized image for the participant, thereby to create a composite image for the participant.

### FIELD OF THE INVENTION

The present invention relates generally to video games and, more particularly, to an approach for efficiently using computational resources while rendering game screens for multiple participants.

### BACKGROUND

Video games have become a common source of entertainment for virtually every segment of the population. The Internet has been revolutionary in that it has allowed players from all over the world, and hundreds of them at a time, to participate simultaneously in the same video game. Many such games involve a player's character performing various actions as he or she travels through different sections of a virtual world. The player may track his or her character's progress through the virtual world from a certain number of virtual “cameras”, thus giving the player the opportunity to “see” his/her character and its surroundings, whether it be in a particular virtual room, arena or outdoor area. Meanwhile, a server (or group of servers) on the Internet keeps track of gameplay and generates game screens for the various players.

When multiple players' characters have the same viewpoint in the game, it is natural to expect that the same image will be displayed on each player's screen. However, it is not always necessary or desirable for all players to view the same image, even though they may be at the same physical point in the game. For example, consider the scenario where two players from two different countries are in the same virtual room of the video game, and let it be the case that the local laws of these two countries differ in terms of what is allowed to be shown on-screen. In this scenario, it may not be appropriate to always generate the same image for both players. Yet to independently render each player's distinct screen individually, on a per-player basis, consumes considerable computational resources, which can lead to having to curtail the number of players that may simultaneously play the game, thus limiting overall enjoyment of the game.

Thus, it would thus be desirable to devise a method for efficiently rendering game screens for players who may have the same viewpoint in the game but have individual per-player needs for customized graphics.

### SUMMARY OF THE INVENTION

Various non-limiting aspects of the invention are set out in the following clauses:
1. A method for creating and sending video game images, comprising: identifying a scene being viewed by a participant in a video game;
   determining whether there exists a previously created image corresponding to the scene and corresponding to a participant category to which the participant belongs;
   in response to the determining being positive, retrieving the previously created image and releasing the retrieved image towards a device associated with the participant;
   in response to the determining being negative, rendering an image corresponding to the scene and corresponding to the participant category, and releasing the rendered image towards a device associated with the participant.
2. The method defined in clause 1, wherein identifying the scene comprises identifying one of a plurality of fixed virtual cameras in the video game.
3. The method defined in clause 1, wherein identifying the scene comprises identifying a position, direction and field of view associated with a character controlled by the participant.
4. The method defined in any one of clauses 1 to 3, wherein determining whether there exists a previously created image corresponding to the scene and corresponding to the participant category to which the participant belongs comprises consulting a database on the basis of an identifier of the scene and an identifier of the participant category.
5. The method defined in any one of clauses 1 to 4, wherein rendering the image corresponding to the scene and corresponding to the participant category comprises identifying a plurality of objects associated with the scene and customizing at least one of the objects in accordance with the participant category.
6. The method defined in clause 5, wherein customizing a given one of the objects in accordance with the participant category comprises determining an object property associated with the participant category and applying the object property to the given one of the objects.
7. The method defined in clause 6, wherein the object property associated with the participant category comprises a texture uniquely associated with the participant category.
8. The method defined in clause 6, wherein the object property associated with the participant category comprises a shading function uniquely associated with the participant category.
9. The method defined in clause 6, wherein the object property associated with the participant category comprises a color uniquely associated with the participant category.
10. The method defined in any one of clauses 6 to 9, further comprising determining the participant category to which the participant belongs and looking up the object property in a database on the basis of the participant category.
11. The method defined in any one of clauses 1 to 10, further comprising obtaining an identifier of the participant, wherein determining the participant category comprises consulting a database on the basis of the identifier of the participant.
12. The method defined in any one of clauses 1 to 11, wherein retrieving the previously created image comprises consulting a database on the basis of the participant category and the scene.
13. The method defined in clause 12, wherein subsequent to creating an image, the method further comprises storing the created image in the database in association with the participant category and the scene.
14. The method defined in any one of clauses 1 to 13, further comprising encoding the image prior to the releasing.
15. The method defined in any one of clauses 1 to 14, wherein the participant category is one of a plurality of participant categories corresponding to different respective population groups.
16. The method defined in any one of clauses 1 to 14, wherein the participant category is one of a plurality of participant categories corresponding to different respective languages.
17. The method defined in any one of clauses 1 to 14, wherein the participant category is one of a plurality of participant categories corresponding to different respective geographic regions.
18. The method defined in any one of clauses 1 to 14, wherein the participant category is one of a plurality of participant categories corresponding to different respective local laws.
19. The method defined in any one of clauses 1 to 14, wherein the participant category is one of a plurality of participant categories corresponding to different respective age groups.
20. The method defined in any one of clauses 1 to 14, wherein the participant category is one of a plurality of participant categories corresponding to different respective levels of gameplay experience.
21. A non-transitory computer-readable medium storing instructions for execution by at least one processor of a computing device, wherein execution of the instructions by the at least one processor of the computing device causes the computing device to implement a method for creating and sending video game images, comprising:
   identifying a scene being viewed by a participant in a video game;
   determining whether there exists a previously created image corresponding to the scene and corresponding to a participant category to which the participant belongs;
   in response to the determining being positive, retrieving the previously created image and releasing the retrieved image towards a device associated with the participant;
   in response to the determining being negative, rendering an image corresponding to the scene and corresponding to the participant category, and releasing the rendered image towards a device associated with the participant.
22. A method of rendering a scene in a video game, comprising:
   identifying a set of objects to be rendered; and
   rendering the set of objects into a plurality of different images for the same scene, the different images being associated with different groups of participants.
23. The method defined in clause 22, wherein rendering the set of objects into a plurality of different images for the same scene comprises rendering the set of objects into a first image associated with a first participant category and a second image associated with a second participant category.
24. The method defined in clause 23, wherein rendering the set of objects into the first image associated with the first participant category comprises customizing at least one of the objects in accordance with the first participant category and wherein rendering the set of objects into the second image associated with the second participant category comprises customizing the at least one of the objects in accordance with the second participant category.
25. The method defined in clause 24, wherein customizing the given one of the objects in accordance with the first participant category comprises determining a first object property associated with the first participant category and applying the first object property to the given one of the objects, and wherein customizing the given one of the objects in accordance with the second participant category comprises determining a second object property associated with the second participant category and applying the second object property to the given one of the objects.
26. The method defined in clause 25, wherein the first object property associated with the first participant category comprises a texture uniquely associated with the first participant category and wherein the second object property associated with the second participant category comprises a texture uniquely associated with the second participant category.
27. The method defined in clause 25, wherein the first object property associated with the first participant category comprises a shading function uniquely associated with the first participant category and wherein the second object property associated with the second participant category comprises a shading function uniquely associated with the second participant category.
28. The method defined in clause 25, wherein the first object property associated with the first participant category comprises a color uniquely associated with the first participant category and wherein the second object property associated with the second participant category comprises a color uniquely associated with the second participant category.
29. The method defined in any one of clauses 22 to 28, wherein the different groups of participants correspond to different respective languages.
30. The method defined in any one of clauses 22 to 28, wherein the different groups of participants correspond to different respective geographic regions.
31. The method defined in any one of clauses 22 to 28, wherein the different groups of participants correspond to different respective local laws.
32. The method defined in any one of clauses 22 to 28, wherein the different groups of participants correspond to different respective age groups.
33. The method defined in any one of clauses 22 to 28, wherein the different groups of participants correspond to different respective levels of gameplay experience.
34. A non-transitory computer-readable medium storing instructions for execution by at least one processor of a computing device, wherein execution of the instructions by the at least one processor of the computing device causes the computing device to implement a method for rendering a scene in a video game, comprising:
   identifying a set of objects to be rendered; and
   rendering the set of objects into a plurality of different images for the same scene, the different images being associated with different groups of participants.
35. A method for transmitting video game images, comprising:
   sending a first image of a video game scene to a plurality of participants in a first participant category, the first image being customized for the first participant category; and
   sending a second image of the same video game scene to a plurality of participants in a second participant category, the second image being customized for the second participant category, the first and second images being different images of the same video game scene.
36. The method defined in clause 35, wherein the first image is rendered once for a particular one of the participants in the first participant category and thereafter copies of the rendered first image are distributed to other ones of the participants in the first participant category.
37. The method defined in clause 35 or clause 36, wherein to render the first image, the method comprises:
   identifying a plurality of objects common to the scene;
   identifying a plurality of first objects common to the first participant category;
   rendering the objects common to the scene and the first objects into the first image.
38. The method defined in any one of clauses 35 to 37, wherein the second image is rendered once for a particular one of the participants in the second participant category and thereafter copies of the rendered second image are distributed to other ones of the participants in the second participant category.
39. The method defined in any one of clauses 35 to 38, wherein to render the second image, the method comprises:
   identifying a plurality of second objects common to the second participant category;
   rendering the objects common to the scene and the second objects into the second image.
40. The method defined in any one of clauses 35 to 39, wherein the first and second participant categories correspond to different respective languages.
41. The method defined in any one of clauses 35 to 39, wherein the first and second participant categories correspond to different respective geographic regions.
42. The method defined in any one of clauses 35 to 39, wherein the first and second participant categories correspond to different respective local laws.
43. The method defined in any one of clauses 35 to 39, wherein the first and second participant categories correspond to different respective age groups.
44. The method defined in any one of clauses 35 to 39, wherein the first and second participant categories correspond to different respective levels of gameplay experience.
45. The method defined in clause 36, further comprising storing the first image in the memory in association with the scene and the first participant category, wherein the copies of the first image are retrieved from the memory.
46. The method defined in clause 38, further comprising storing the first image in the memory in association with the scene and the first participant category, wherein the copies of the first image are retrieved from the memory.
47. The method defined in any one of clauses 35 to 47, further comprising:
   encoding the first image prior to sending; and
   encoding the second image prior to sending.
48. A non-transitory computer-readable medium storing instructions for execution by at least one processor of a computing device, wherein execution of the instructions by the at least one processor of the computing device causes the computing device to implement a method for video game image distribution, comprising:
   sending a first image of a video game scene to a plurality of participants in a first participant category, the first image being customized for the first participant category; and
   sending a second image of the same video game scene to a plurality of participants in a second participant category, the second image being customized for the second participant category, the first and second images being different images of the same video game scene.
49. A method for control of video game rendering, comprising:
   identifying a scene being viewed by a participant in a video game;
   obtaining an image for the scene;
   rendering at least one customized image for the participant;
   combining the image for the scene and the at least one customized image for the participant, thereby to create a composite image for the participant.
50. The method defined in clause 49, further comprising:
   determining whether there exists in memory a previously created image for the scene;
   wherein when the response to the determining is positive, the obtaining comprises retrieving the previously created image from the memory;
   wherein when the response to the determining is negative, the obtaining comprises rendering an image corresponding to the scene.
51. The method defined in clause 49 or clause 50, wherein rendering the at least one customized image for the participant comprises identifying at least one object to be rendered and rendering the at least one object.
52. The method defined in clause 51, wherein appearance of the at least one object in the customized image for the participant provides the participant with a playing advantage over other participants for which the at least one object is not rendered.
53. The method defined in clause 51, wherein appearance of the at least one object in the customized image for the participant provides the participant with a playing disadvantage over other participants for which the at least one object is not rendered.
54. The method defined in clause 51, wherein appearance of the at least one object in the customized image for the participant provides the participant with occluded vision.
55. The method defined in clause 51, wherein the at least one object comprises an object that is represented in the customized image for the participant and in no other customized image for any other participant.
56. The method defined in clause 51, wherein the at least one object is part of a heads-up display (HUD).
57. The method defined in clause 51, wherein the at least one object comprises a message from another player.
58. The method defined in any one of clauses 51 to 57, implemented by a server system, wherein the at least one object comprises a message from the server system.
59. The method defined in any one of clauses 51 to 57, wherein the at least one object comprises an advertisement.
60. The method defined in any one of clauses 51 to 59, further comprising selecting the at least one object based on demographic information about the participant.
61. The method defined in any one of clauses 51 to 59, further comprising selecting the at least one object based on whether the participant is a premium subscriber to the video game.
62. The method defined in any one of clauses 49 to 61, wherein identifying the is scene comprises identifying one of a plurality of fixed virtual cameras in the video game.
63. The method defined in any one of clauses 49 to 61, wherein identifying the scene comprises identifying a position, direction and field of view associated with a character controlled by the participant.
64. The method defined in any one of clauses 49 to 63, further comprising releasing the composite image towards a device associated with the participant.
65. The method defined in any one of clauses 49 to 64, wherein the combining comprises alpha blending the image for the scene and the customized image for the participant.
66. The method defined in any one of clauses 49 to 65, the participant being a first participant, the composite image being a first composite image, wherein the scene is also being viewed by a second participant in the video game, and wherein the method further comprises:
   rendering at least one second customized image for the second participant;
   combining the image for the scene and the at least one second customized image for the second participant, thereby to create a second composite image for the second participant.
67. The method defined in clause 66, wherein rendering the at least one second customized image for the second participant comprises identifying at least one second object to be rendered and rendering the at least one second object.
68. The method defined in clause 67, wherein the at least one second object comprises an object that is represented in the second customized image for the second participant and not in the first customized image for the first participant.
69. The method defined in any one of clauses 66 to 68, further comprising releasing the second composite image towards a device associated with the second participant.
70. A non-transitory computer-readable medium storing instructions for execution by at least one processor of a computing device, wherein execution of the instructions by the at least one processor of the computing device causes the computing device to implement a method for control of video game rendering, the method comprising:
   identifying a scene being viewed by a participant in a video game;
   obtaining an image for the scene;
   rendering at least one customized image for the participant;
   combining the image for the scene and the at least one customized image for the participant, thereby to create a composite image for the participant.
71. A method for control of video game rendering, comprising:
   identifying a scene being viewed by a participant in a video game;
   determining whether an image for the scene has been previously rendered;
   in response to the determining being positive, retrieving the image for the scene, otherwise rendering the image for the scene;
   rendering at least one customized image for the participant;
   sending to the participant the image for the scene and the at least one customized image for the participant.
72. The method defined in clause 71, wherein identifying the scene comprises identifying one of a plurality of fixed virtual cameras in the video game.
73. The method defined in clause 71, wherein identifying the scene comprises identifying a position, direction and field of view associated with a character controlled by the participant.
74. The method defined in any one of clauses 71 to 73, wherein retrieving the image for the scene comprises consulting a database on the basis of an identifier of the scene.
75. The method defined in clause 74, wherein subsequent to rendering the image for the scene, the method further comprises storing the rendered image in the database in association with the identifier of scene.
76. The method defined in any one of clauses 71 to 75, further comprising encoding the image for the scene and the at least one customized image prior to the sending.
77. The method defined in any one of clauses 71 to 76, wherein rendering the at least one customized image for the participant comprises identifying at least one object to be rendered and rendering the at least one object.
78. The method defined in clause 77, wherein representing the at least one object in the customized image for the participant provides the participant with a playing advantage over other participants for which the at least one object is not rendered.
79. The method defined in clause 77, wherein representing the at least one object in the customized image for the participant provides the participant with a playing disadvantage over other participants for which the at least one object is not rendered.
80. The method defined in clause 77, wherein representing the at least one object in the customized image for the participant provides the participant with occluded vision.
81. The method defined in clause 77, wherein the at least one object comprises an object that is represented in the customized image for the participant and in no other customized image for any other participant.
82. The method defined in clause 77, wherein the at least one object is part of a heads-up display (HUD).
83. The method defined in clause 77, wherein the at least one object comprises a message from another player.
84. The method defined in clause 77, implemented by a server system, wherein the at least one object is a message from the server system.
85. The method defined in clause 77, wherein the at least one object comprises an advertisement.
86. The method defined in any one of clauses 77 to 85, further comprising selecting the at least one object based on demographic information about the participant.
87. The method defined in any one of clauses 77 to 85, further comprising selecting the at least one object based on whether the participant is a premium subscriber to the video game.
88. The method defined in any one of clauses 71 to 76, wherein rendering the at least one customized image for the participant comprises identifying a plurality of sets of objects to be rendered and rendering each set of objects into a separate customized image for the participant.
89. A non-transitory computer-readable medium storing instructions for execution by at least one processor of a computing device, wherein execution of the instructions by the at least one processor of the computing device causes the computing device to implement a method for control of video game rendering, comprising:
   identifying a scene being viewed by a participant in a video game;
   determining whether an image for the scene has been previously rendered;
   in response to the determining being positive, retrieving the image for the scene, otherwise rendering the image for the scene;
   rendering at least one customized image for the participant;
   sending to the participant the image for the scene and the at least one customized image for the participant.
90. A method for control of game screen rendering at a client device associated with a participant in a video game, comprising:
   receiving a first image common to a group of participants viewing a same scene in a video game;
   receiving a second image customized for the participant;
   combining the first and second images into a composite image; and
   displaying the composite image on the client device.
91. The method defined in clause 90, wherein combining the first and second images into the composite image comprises alpha blending of the first and second images.
92. The method defined in clause 90 or clause 91, wherein the first and second images are encoded, the method further comprising decoding the first and second images before combining them into the composite image.
93. The method defined in any one of clauses 90 to 92, the scene being derived from a selection made by a user of the client device, the method further comprising transmitting a signal to a server system, the signal indicative of the selection made by the user.
94. A mobile communication device configured for implementing the method of any one of clauses 90 to 93.
95. A non-transitory computer-readable medium storing instructions for execution by at least one processor of a computing device, wherein execution of the instructions by the at least one processor of the computing device causes the computing device to implement a method for control of game screen rendering at a client device associated with a participant in a video game, the method comprising:
   receiving a first image common to a group of participants viewing a same scene in a video game;
   receiving a second image customized for the participant;
   combining the first and second images into a composite image; and
   displaying the composite image on the client device.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram of a video game system architecture, according to a non-limiting embodiment of the present invention;

FIG. 2 is a block diagram showing various functional modules of a server system used in the video game system architecture of FIG. 1, according to a non-limiting embodiment of the present invention;

FIG. 3 depicts a business database that stores a variety of information about participants in the video game;

FIG. 4 is a flowchart illustrating the steps in a main loop carried out by the server system when executing a video game program for a given participant, according to a first non-limiting embodiment of the present invention;

FIG. 5 is a flowchart showing example actions taken by the client device, in the case where the main processing loop is executed in accordance with the flowchart of FIG. 4;

FIG. 6 is a flowchart showing detailed execution of a rendering control sub-routine, in accordance with a non-limiting embodiment of the present invention;

FIG. 7 depicts a scene mapping database that stores an association between participant identifiers and scene identifiers;

FIG. 8 depicts an image database that stores an association between participant categories, scene identifiers and image pointers;

FIGS. 9A to 9D are non-limiting examples of a customization table used to indicate customization for various objects on the basis of participant category;

FIG. 10 is a flowchart showing detailed execution of a rendering control sub-routine, in accordance with a further non-limiting embodiment of the present invention;

FIG. 11 depicts an image database that stores an association between scene identifiers and image pointers;

FIG. 12 illustrates a non-limiting example of a customized object list, which indicates objects to be custom rendered for a given participant;

FIG. 13 is a flowchart illustrating the steps in a main loop carried out by the server system when executing a video game program for a given participant, according to a second non-limiting embodiment of the present invention;

FIG. 14 is a flowchart showing example actions taken by the client device, in the case where the main processing loop is executed in accordance with the flowchart of FIG. 13; and

FIG. 15 illustrates an example virtual world that includes a plurality of fixed-position cameras.

### DETAILED DESCRIPTION

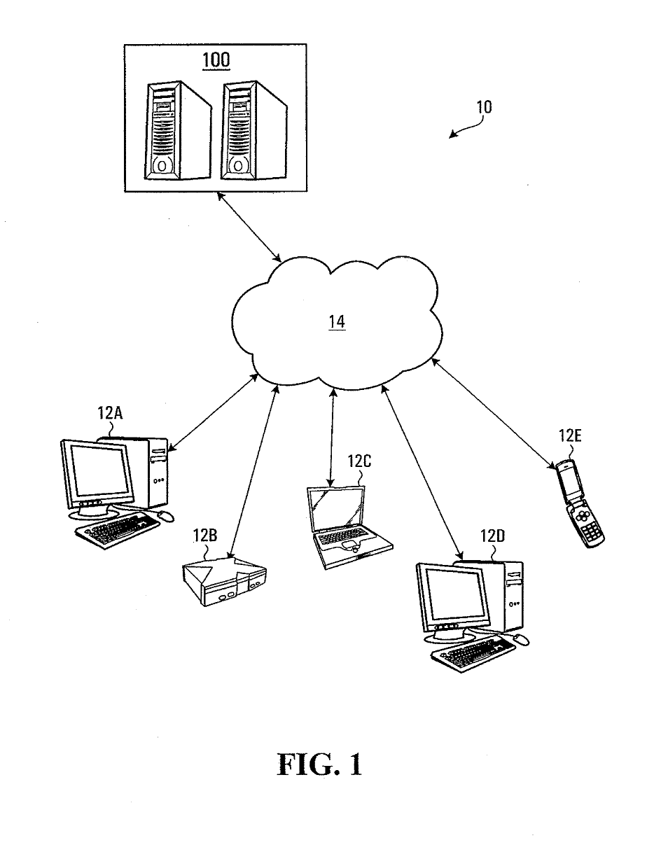

FIG. 1 shows an architecture of a video game system 10 according to a non-limiting embodiment of the present invention, in which client devices 12a-e are connected to a server system 100 across a network 14 such as the Internet or a private data network. In a non-limiting embodiment, the server system 100 may be configured so as to enable users of the client devices 12a-e to play a video game, either individually or collectively. A video game may include a game that is played for entertainment, education, sport, with or without the possibility of monetary gain (gambling). The server system 100 may comprise a single server or a cluster of servers connected through, for example, a virtual private network (VPN) and/or a data center. Individual servers within the cluster may be configured to carry out specialized functions. For example, one or more servers may be primarily responsible for graphics rendering.

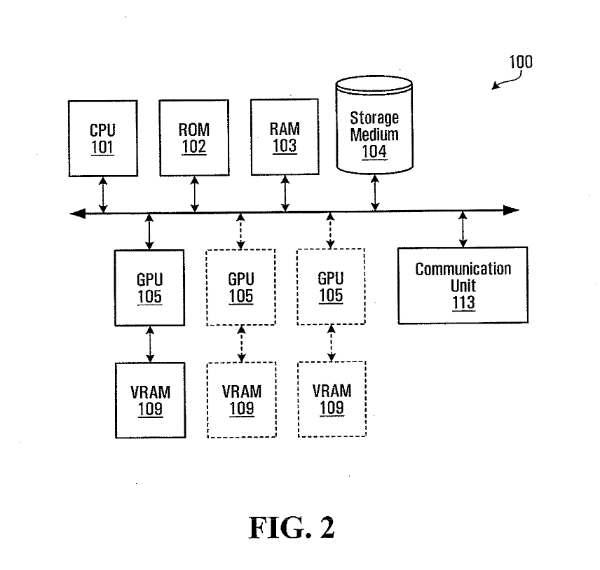

With reference to FIG. 2, the server system 100 may include one or more servers, each with a CPU 101. In a non-limiting embodiment, the CPU 101 may load video game program instructions into a local memory 103 (e.g., RAM) and then may execute them. In a non-limiting embodiment, the video game program instructions may be loaded into the local memory 103 from a ROM 102 or from a storage medium 104. The ROM 102 may be, for example, a programmable non-volatile memory which, in addition to storing the video game program instructions, may also store other sets of program instructions as well as data required for the operation of various modules of the server system 100. The storage medium 104 may be, for example, a mass storage device such as an HDD detachable from the server system 100. The storage medium 104 may also serve as a database for storing information about participants involved the video game, as well as other kinds of information that may be required to generate output for the various participants in the video game.

The video game program instructions may include instructions for monitoring/controlling gameplay and for controlling the rendering of game screens for the various participants in the video game. The rendering of game screens may be executed by invoking one or more specialized processors referred to as graphics processing units (GPUs) 105. Each GPU 105 may be connected to a video memory 109 (e.g., VRAM), which may provide a temporary storage area for rendering a game screen. When performing rendering, data for an object in three-dimensional space may be loaded into a cache memory (not shown) of the GPU 105. This data may be transformed by the GPU 105 into data in two-dimensional space, which may be stored in the VRAM 109. Although each GPU 105 is shown as being connected to only one video memory 109, the number of video memories 109 connected to the GPU 105 may be any arbitrary number. It should also be appreciated that in a distributed rendering implementation, the CPU 101 and the GPUs 105 may be located on separate computing devices.

Also provided in the server system 100 is a communication unit 113 which may implement a communication interface. The communication unit 113 may exchange data with the client devices 12a-e over the network 14. Specifically, the communication unit 113 may receive user inputs from the client devices 12a-e and may transmit data to the client devices 12a-e. As will be seen later on, the data transmitted to the client devices 12a-e may include encoded images of game screens or portions thereof. Where necessary or appropriate, the communication 113 unit may convert data into a format compliant with a suitable communication protocol.

Turning now to the client devices 12a-e, their configuration is not particularly limited. In some embodiments, one or more of the client devices 12a-e may be, for example, a PC, a home game machine (console such as XBOX™, PS3™, Wii™ etc.), or a portable game machine. In other embodiments, one or more of the client devices 12a-e may be a communication or computing device such as a mobile phone, a PDA, or a tablet.

The client devices 12a-e may be equipped with input devices (such as a touch screen, a keyboard, a game controller, a joystick, etc.) to allow users of the client devices 12a-e to provide input and participate in the video game. In other embodiments, the user of a given one of the client devices 12a-e may produce body motion or wave an external object; these movements are detected by a camera or other sensor (e.g., Kinect™), while software operating within the client device attempts to correctly guess whether the user intended to provide input to the client device and, if so, the nature of such input. In addition, each of the client devices 12a-e may include a display for displaying game screens, and possibly also a loudspeaker for outputting audio. Other output devices may also be provided, such as an electro-mechanical system to induce motion, and so on.

### Business Database

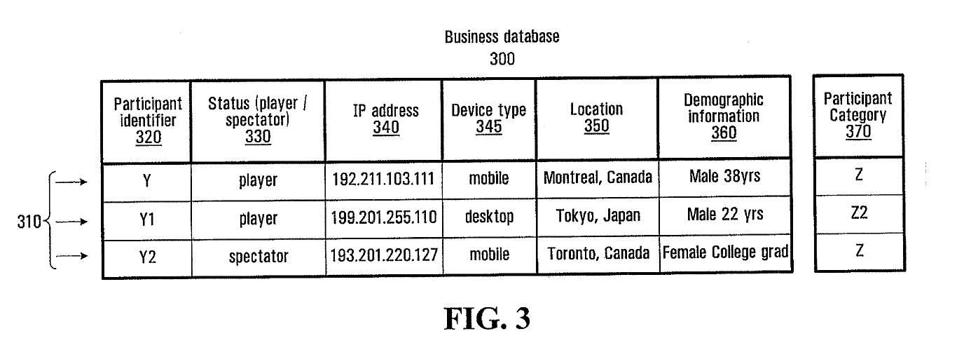

In accordance with a non-limiting embodiment of the present invention, when a participant joins a game, the server system 100 creates a record in a business database. A “participant” is meant to encompass players (who control active characters or avatars) and spectators (who simply observe other players' gameplay but otherwise do not control an active character in the game). With reference to FIG. 3, a business database 300 may include a plurality of records 310, each of which comprises a plurality of fields. These fields may include a participant identifier field 320, a status field 330, an IP address field 340, a client device type field 345, a location field 350, a demographic information field 360, etc. The participant identifier field 320 includes an identifier of the participant for whom the record has been created. The status field 330 indicates whether this participant is a player or a spectator. The IP address field 340 indicates the IP address of the client device being used by the participant. The device type field 345 specifies the type of client device being used by the participant, such as the make, model, operating system, MNO (mobile network operator), etc. The location field 350 specifies the physical location of the participant, which may include geographic (latitude/longitude) coordinates, a postal code, a city name, etc. The demographic information field 360 may include information such as age, gender, income level, and possibly other relevant data. Additionally, a field (not shown) may be provided to indicate whether the participant is a premium subscriber (e.g., pays for one or more special services associated with the video game). It should be appreciated that not all fields are necessary. However, the more information that can be gathered about a given participant, the more precisely one can customize information for that participant.

In some embodiments, the business database 300 may include a participant category field 370 for one or more records 310. The participant category field 370 specifies a category to which a given participant belongs. This allows multiple participants to be grouped together in accordance with a common feature or combination of features. Such grouping can be useful where it is desired that participants sharing a certain set of features see a particular object on their screens in a particular way. Categorization of participants can be done according to, for example, location, device type, status, IP address, demographic information or a combination thereof. Moreover, participant categories may be created on the basis of information that does not appear in the business database as illustrated in FIG. 3. Generally speaking, participant categorization can be effected on the basis of any characteristic that comes in a plurality of variants, where each variant has a tendency to be common to a significant subset of the participants. Examples of characteristics can further include time zone, religion, preferences (e.g., sports, color, movie genre, clothing), employer, and so on. Thus, a “participant category” can refer to one of several population groupings that can be divided based on a set of underlying characteristics. It is also within the scope of the present invention for participant categorization to be effected on the basis of a characteristic that is unique to each participant, i.e., there may be even just a single participant in a given participant category.

In the specific nonlimiting example embodiment of the business database 300 in FIG. 3, it will be seen that three records 310 have been created. The first record is associated with a participant identified by Y, the second record is associated with a participant identified by Y1 and the third record is associated with a participant identified by Y2. From the record associated with participant Y, it can be observed that participant Y is a player (as opposed to a spectator), is a 38-year-old male in Montreal, Canada, and is using a mobile device with IP address 192.211.103.111. In the case of participant Y1, this participant is also a player (as opposed to a spectator), is a 22-year-old male in Tokyo, Japan and is using a desktop with IP address 199.201.255.110. Finally, in the case of participant Y2, this individual is female college graduate who is a spectator of the game based in Toronto, Canada, and is using a mobile device with IP address 193.201.220.127. In the present example, categorization is carried out on the basis of device type and location. That is to say, participants who use similar or identical device types and are located in the same city or proximate one another will be grouped together. As such, participants Y and Y2 (each of whom is using a mobile device and is located in Eastern Canada) are each associated with a common category Z. On the other hand, participant Y1 has been associated with a different category, namely Z2. Of course, the aforementioned categorization is merely an example, and any conceivable categorization may be applied.

### Game Screen Creation by Main Game Loop

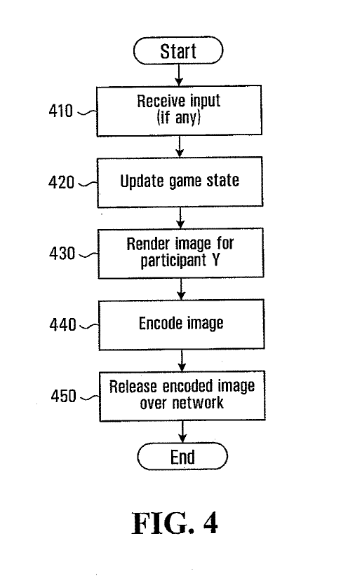

Reference is now made to FIG. 4, which conceptually illustrates the steps in a main processing loop (or main game loop) of the video game program implemented by the server system 100. The main game loop may be executed for each participant in the game, thereby causing an image to be rendered for each of the client devices 12a-e. To simplify the description, the embodiments to be described below will assume that the main game loop is executing for a participant denoted “participant Y”. However, it should be understood that an analogous main game loop also executes for each of the other participants in the video game.

The main game loop may include steps 410 to 450, which are described below in further detail, in accordance with a non-limiting embodiment of the present invention. The main game loop for each participant (including participant Y) continually executes on a frame-by-frame basis. Since the human eye perceives fluidity of motion when at least approximately twenty-four (24) frames are presented per second, the main game loop may execute at least 24 times per second, such as 30 or 60 times per second, for each participant (including participant Y). However, this is not a requirement of the present invention.

At step 410, inputs may be received. This step may not be executed for certain passes through the main game loop. The inputs, if there are any, may be received in the form of signals transmitted from various client devices 12a-e through a back channel over the network 14. These signals may be sent by the client devices 12a-e further to detecting user actions, or they may be generated autonomously by the client devices 12a-e themselves. The input from a given client device may convey that the user of the client device wishes to cause a character under his or her control to move, jump, kick, turn, swing, pull, grab, etc. Alternatively or in addition, the input from a given client device may convey that the user of the client device wishes to select a particular virtual camera view (e.g., first-person or third-person) or reposition his or her viewpoint within the virtual world maintained by the video game program.

At step 420, the game state of the video game may be updated based at least in part on the inputs received at step 410 and other parameters. By “game state” is meant the state (or properties) of the various objects existing in the virtual world maintained by the video game program. These objects may include playing characters, non-playing characters and other objects. In the case of a playing character, properties that can be updated may include: position, strength, weapons/armor, lifetime left, special powers, speed/direction (velocity), animation, visual effects, energy, ammunition, etc. In the case of other objects (such as background, vegetation, buildings, vehicles, terrain, weather, etc.), properties that can be updated may include the position, velocity, animation, damage/health, visual effects, etc. It should be appreciated that parameters other than user inputs can influence the above properties of the playing characters, nonplaying characters and other objects. For example, various timers (such as elapsed time, time since a particular event, virtual time of day, etc.) can have an effect on the game state of playing characters, non-playing characters and other objects. The game state of the video game may be stored in a memory such as the storage medium 104.

At step 430, an image may be rendered for participant Y. For convenience, step 430 is referred to as a rendering control sub-routine. Control of rendering can be done in numerous ways, as will be described below with reference to several non-limiting embodiments of the rendering control subroutine 430. In the below, reference will be made to an image, which can be an arrangement of pixels in two or three dimensions, with a color value expressed in accordance with any suitable format. It is also within the scope of the present invention for audio information as well as other ancillary information to accompany the image.

At step 440, the image may be encoded by an encoding process, resulting in an encoded image. In a non-limiting embodiment, an “encoding process” refers to the processing carried out by a video encoder (or codec) implemented by the server system 100. A video codec is a device (or set of instructions) that enables or carries out or defines a video compression or decompression algorithm for digital video. Video compression transforms an original stream of digital data (expressed in terms of pixel locations, color values, etc.) into a compressed stream of digital data that conveys the same information but using fewer bits. There is a balance to be achieved between the video quality, the quantity of the data needed to represent a given image on average (also known as the bit rate), the complexity of the encoding and decoding algorithms, the robustness to data losses and errors, the ease of editing, the ability to access data at random, the end-to-end delay, and a number of other factors. As such, many customized methods of compression have been developed, with varying levels of computational speed, memory requirements and degrees of fidelity (or loss). Examples of an encoding process include H.263 and H.264. In some embodiments, encoding may be specifically adapted for different types of client devices. Knowledge of which client device is being used by the given participant can be obtained by consulting the business database 300 (in particular, the device type field 345), which was previously described. In addition to data compression, the encoding process used to encode a particular image may or may not apply cryptographic encryption.

At step 450, the encoded image created for participant Y at step 440 may be released/sent over the network 14. For example, step 450 may include the creation of packets, each having a header and a payload. The header may include an address of a client device associated with participant Y, while the payload may include the encoded image. In a non-limiting embodiment, the compression algorithm used to encode a given image may be encoded in the content of one or more packets that convey the given image. Other methods of transmitting the encoded images will occur to those of skill in the art.

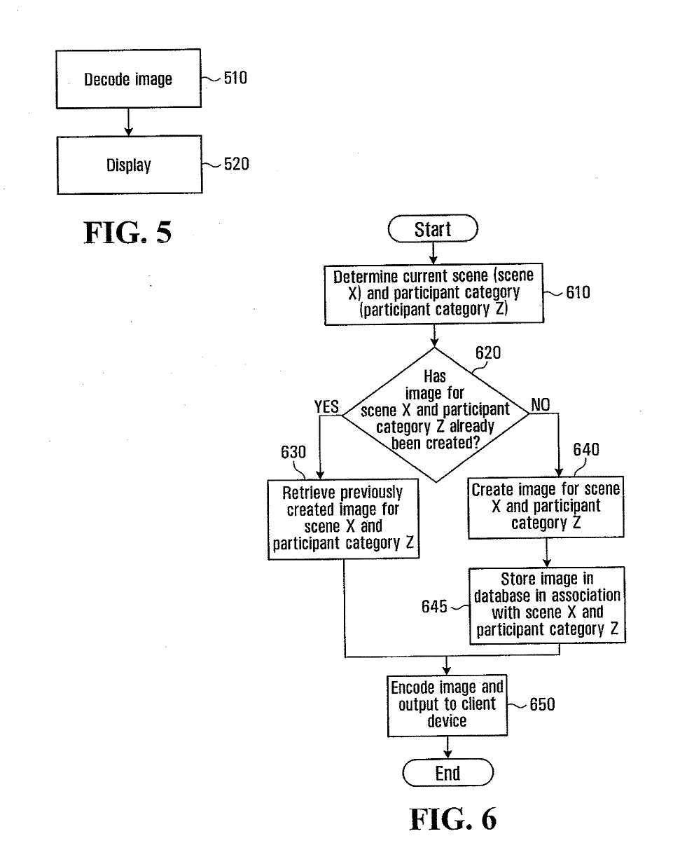

The encoded image travels over the network 14 and arrives at participant Y's client device. FIG. 5 shows steps 510 and 520, which are executed at the client device upon receipt of the encoded image. Specifically, at step 510, the client device decodes the encoded image, thereby to obtain the image that was originally produced at step 430. The image decoded in this manner is then displayed on the client device at step 520.

### Rendering Control Sub-Routine (First Embodiment)

A first non-limiting example embodiment of the rendering control sub-routine 430 is now described with reference to FIG. 6.

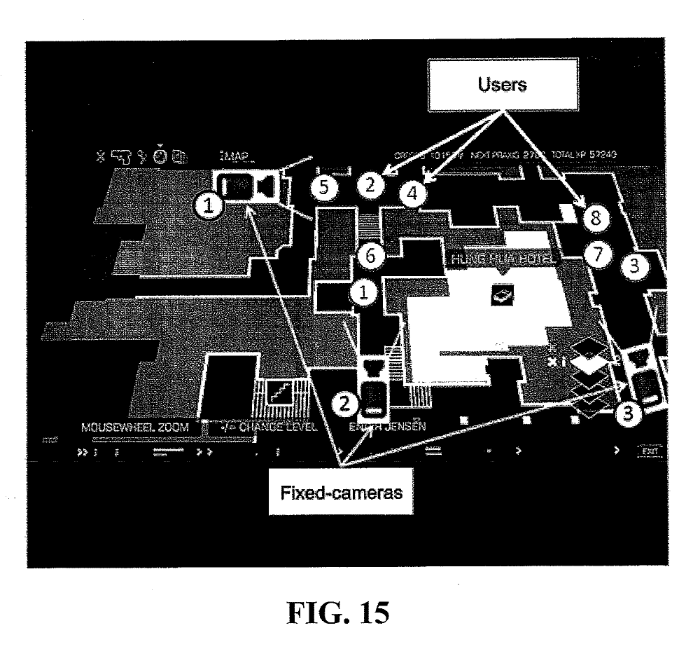

At step 610, the rendering control sub-routine 430 determines the current scene (also referred to as a view, perspective or camera position) for participant Y. The current scene may refer to the section of the game world that is currently being perceived by participant Y. In one embodiment, the current scene may be a room in the game world as “seen” by a third-person virtual camera occupying a position in that room. In another embodiment, the current scene may be specified by a two-dimensional or three-dimensional position of participant Y's character together with a gaze angle and a field of view. For example, consider FIG. 15, which depicts a game world in which there are several camera positions. In this example, there are eight participants and three third-person camera positions. In addition, each of the participants may have access to a first-person camera, whose field of view emanates from that participant. The current scene for a particular participant may depend on a variety of factors, such as the position and orientation of the participant within the game world, the location of cameras within the game world, the style of game (i.e., whether the game permits third or first person viewing), whether the participant is a player or a spectator, a viewpoint selection made by the participant, etc.

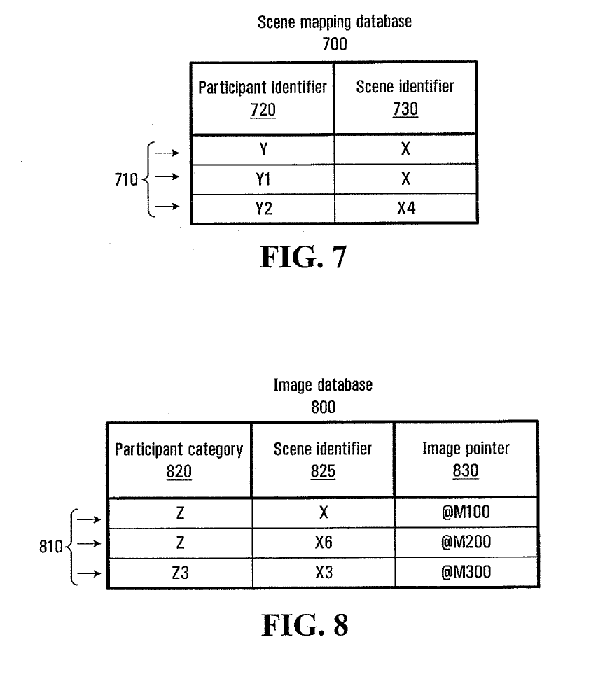

The identity of the current scene for participant Y can be maintained in a database. FIG. 7 shows a scene mapping database 700 that stores an association between each of a plurality of participants and a corresponding current scene for that participant. Specifically, the scene mapping database 700 includes a plurality of records 710, one for each participant. The records 710 each include a participant field 720 and a scene identifier field 730. The participant is identified by a respective participant identifier which occupies the participant field 720, whereas the current scene for the participant is represented by a scene identifier which occupies the scene identifier field 730. In one embodiment, the scene identifier may simply be the identifier of a fixed camera that provides one of several third-person viewpoints. In a more complex embodiment, the scene identifier may encode a two-dimensional or three-dimensional position of a character together with a gaze angle and a field of view. Other possibilities will now become apparent to those of skill in the art. In addition, some embodiments may contemplate more than one current scene being associated with a given participant, as may be the case in a split-screen scenario.

In the example scene mapping database 700 of FIG. 7, participant Y is associated with scene X, participant Y1 is also associated with scene X and participant Y2 is associated with scene X4. Therefore, one observation that can be made is that participants Y and Y1 are currently viewing the same scene, namely scene X. Of course, this is merely an example that serves to illustrate how the scene mapping database 700 may be populated.

Also as part of step 610, the rendering control subroutine 430 determines the participant category associated with participant Y. To this end, the rendering control subroutine 430 may access the business database 300, where the content of the participant category field 370 is retrieved. In the specific case of participant Y, it will be observed that the content of the participant category field 370 for participant Y is the value Z. Therefore, participant category Z is retrieved for participant Y.

Having determined that participant Y is associated with scene X and category Z, the rendering control subroutine 430 proceeds to step 620, whereby it is determined whether an image for scene X and participant category Z has already been created. This may be achieved by consulting an image database. With reference to FIG. 8, an image database 800 may include a plurality of records 810. Each record 810 may include a participant category field 820, a scene identifier field 825 and a corresponding image pointer field 830. The records 810 are accessed on the basis of a particular combination of the participant category and the scene identifier so as to determine a corresponding image pointer. Specifically, the image pointer field 830 includes a pointer which points to a location in memory that stores a rendered image for the particular combination of the participant category and the scene identifier. When the pointer field 830 is null, this signifies that no image has yet been rendered for the particular combination of the participant category and the scene identifier.

In the example image database 800 of FIG. 8, images have been created for various combinations of the participant category and the scene identifier. In particular, an image for the combination of participant category Z and scene identifier X is referenced by the pointer @M100, an image for the combination of participant category Z and scene identifier X6 is referenced by the pointer @M200, and an image for the combination of participant category Z3 and scene identifier X3 is referenced by the pointer @M300.

If the outcome of step 620 is “yes”, the rendering control subroutine 430 proceeds to step 630, by virtue of which the previously generated image associated with scene identifier X and participant category Z is retrieved. However, the first time that step 620 is executed, the answer will be “no”. In other words, an image for the particular combination of scene X and participant category Z will not yet have been rendered and it will be necessary to render it. In that case, the rendering control subroutine 430 proceeds to step 640.

At step 640, the rendering control subroutine 430 causes rendering of an image that would be visible to participants sharing the same scene (i.e., scene X) and falling into the same participant category (i.e., category Z).

Accordingly, the rendering control subroutine 430 determines the objects in scene X. For example, a frustum can be applied to the game world, and the objects within than frustum are retained or marked. The frustum has an apex is situated at the location of participant Y (or the location of a camera associated with participant Y) and a directionality defined by the directionality of participant Y's gaze (or the directionality of the camera associated with participant Y). Then, the objects in scene X are rendered into a 2-D image using the GPU 105.

During rendering, and in accordance with a non-limiting embodiment of the present invention, one or more properties of one or more objects can be customized across different participant categories. In a specific non-limiting embodiment, the object property being customized may be an applied texture and/or an applied shading function. For example, there may be variations in the texture and/or shading function applied to the object(s) for participants in different regional, linguistic, social, legal (or other) categories. For instance, it is to be noted that the participant category can have an effect on how to depict insignia, signs of violence, nudity, text, advertisements, etc.

As a first example, consider the case where the participant categories include a first category for which showing blood is acceptable (e.g., adults) and a second category for which showing blood is unacceptable (e.g., children). The first category may include adults and the second category may include children. Consider that the object in question is a pool of blood. In this case, the pool of blood may be rendered in red for the participants in the first category and may be rendered white for the participants in the second category. In this way, adults and children may participate in the same game, while each population group is provided with graphical elements that it may find interesting, acceptable or not offensive.

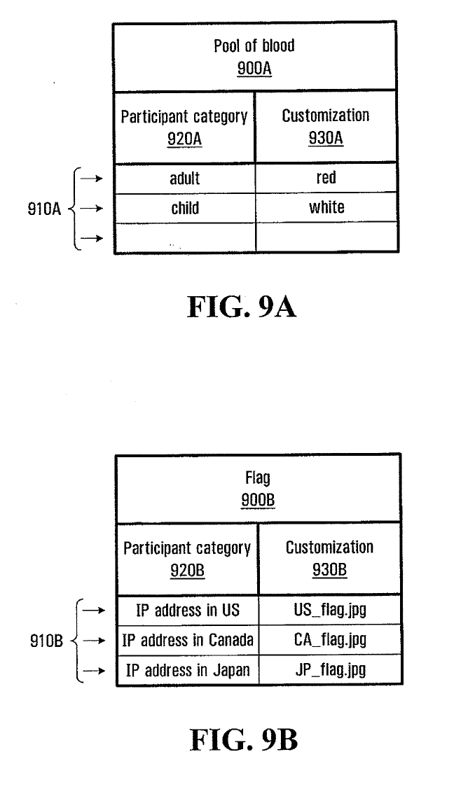

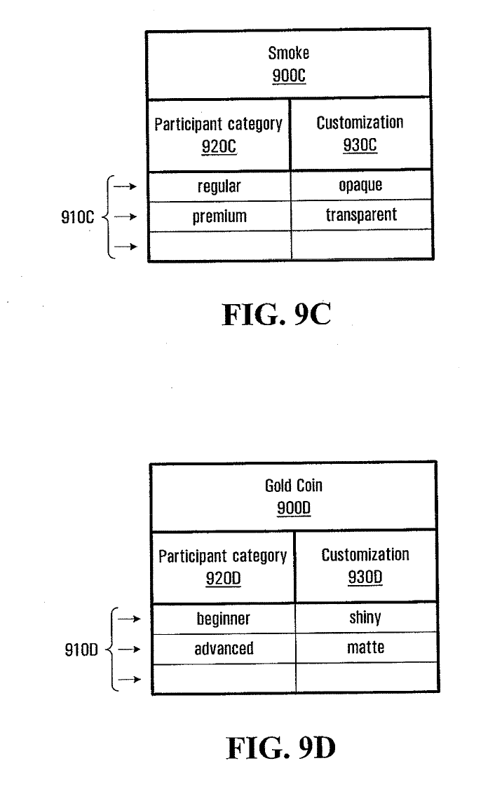

The extent and nature of the customization (e.g., texture, shading, color, etc.) to be applied to a particular object for a particular participant category can be stored in a database, which may be stored in the storage medium 104 or elsewhere. For example, reference is made to FIG. 9A, which shows a customization table 900A for an object referred to as “pool of blood”. The customization table 900A is conceptually illustrated as a plurality of rows 910A, each of which has a participant category field 920A and a customization field 930A. The participant category field 920A stores an indication of the participant category, while the customization field 930A for a particular participant category stores an indication of the object property to be applied to the object (pool of blood) for the particular participant category. The customization field 930A can represent any surface, pattern, design, color, shading or other property that is uniquely associated with a given participant category for the purposes of customizing a customizable object.

By way of non-limiting example, FIG. 9A illustrates the case where the participant categories are “adult” (for which red blood may be acceptable) and “child” (for which red blood may be unacceptable). The customization field 930A for the “adult” participant category is shows as “red”, while the customization field 930A for the “child” participant category is shown as “white”.

As a second example, consider the case where the participant categories include a first category that pertains to participants that have connected from an IP address in the United States, a second category that pertains to participants that have connected from an IP address in Canada and a second category that pertains to participants that have connected from an IP address in Japan.

Consider that the object in question is a flag. In this case, the image used to texture the flag for the first participant category may be the American flag, the image used to texture the flag for the second participant category may be the Canadian flag and the image used to texture the flag for the third participant category may be the Japanese flag. In this way, Americans, Canadians and Japanese participating in same game may find it appealing to have their own flag displayed to them.

By way of non-limiting example, FIG. 9B illustrates a customization table 900B for an object identified as “flag”. In this case, the participant categories are “IP address in U.S.”, “IP address in Canada” and “IP address in Japan”. The customization field 930B for the “IP address in U.S.” participant category is shows as “US_flag.jpg”, the customization field 930B for the “IP address in Canada” participant category is shown as “CA_flag.jpg” and the customization field 930B for the “IP address in Japan” participant category is shown as “JP_flag.jpg”. The content of the customization field may refer to image files of various flags used as textures.

As a third example, consider the case where the participant categories include a first category of “regular” participants and a second category of “premium” participants. Premium status may be achieved due to a threshold score or number of hours played having been reached, or due to having paid a fee to achieve this status. Consider that the object in question is smoke emanating from a grenade that has exploded. In this case, the image used to texture the smoke for participants in either the first or the second participant category may be a conventional depiction of smoke. However, the smoke is given a degree of transparency that is customized, such that the smoke may appear either opaque or see-through, depending on the participant category. This would allow premium participants to gain a playing advantage because their view of the scene would not be occluded by the smoke of the explosion, compared to “regular” participants.

By way of non-limiting example, FIG. 9C illustrates a customization table 900C for an object identified as “smoke”. In this case, the participant categories are “regular” and “premium”. The customization field 930C for the “regular” participant category is shows as “opaque”, while the customization field 930C for the “premium” participant category is shown as “transparent”.

As a fourth example, consider the case where the participant categories include a first category of “beginner” participants and a second category of “advanced” participants. This information may be available in the business database 300. Consider that the game consists of accumulating gold coins. In this case, the gold coins can be somewhat hidden by shading them a certain way for participants in the “advanced” category, whereas the gold coins can be rendered to be particularly shiny for participants in the “beginner” category. This will make the gold coins easier to see for beginners, which could be used to level the playing field between beginners and advanced participants. As such, both categories of participants to play the same game at the same time at a level of difficulty commensurate with their skill.

By way of non-limiting example, FIG. 9D illustrates a customization table 900D for an object identified as “gold coin”. In this case, the participant categories are “beginner” and “advanced”. The customization field 930C for the “beginner” participant category is shows as “shiny”, while the customization field 930D for the “advanced” participant category is shown as “matte”.

Persons skilled in the art will now appreciate that a wide variety of underlying characteristics can be used in order to define participant categories having different “values” of such characteristics. For example, the underlying characteristic may pertain to age, local laws, geography, language, time zone, religion, preferences (e.g., sports, color, movie genre, clothing), employer, etc. Moreover, the number of participant categories (i.e., the number of “values” of the underlying characteristic) is not particularly limited.

The above rendering step can be applied to one or more objects within the game screen rendering range for participant Y, depending on how many objects are being represented in the same image. After rendering is performed, the data in the VRAM 109 will be representative of a two-dimensional image made up of pixels. Each pixel is associated with a color value, which can be an RGB value, a YCbCr value, and the like. In addition, the pixel may be associated with an alpha value, which varies between 0.0 and 1.0 and indicates a degree of transparency.

The rendering control subroutine 430 then proceeds to step 645.

At step 645, the rendered image is stored in memory and a pointer to the image (in this case, @M100) is stored in the image database 800 in association with scene identifier X and participant category Z. As such, it will be seen that the image rendered for scene X will be customized for different participant categories, i.e., they will contain graphical elements that may differ across participant categories, even though they pertain to the same scene in the video game. The rendering control subroutine 430 terminates and the video game program proceeds to step 440, which has been previously described.

As such, when the rendering control subroutine 430 is next executed for another participant that is viewing scene X and falls within participant category Z, the “YES” branch will be taken out of step 620. This leads to step 630, by virtue of which a copy of the previously generated image will be retrieved by referencing pointer @M100. Specifically, the pointer associated with scene identifier X and participant category Z can be obtained from the image database 800, and then the image located at the memory location pointed to by the pointer can be retrieved. It will be noted that the previously generated image does not need to be re-rendered.

### Rendering Control Sub-Routine (Second Embodiment)

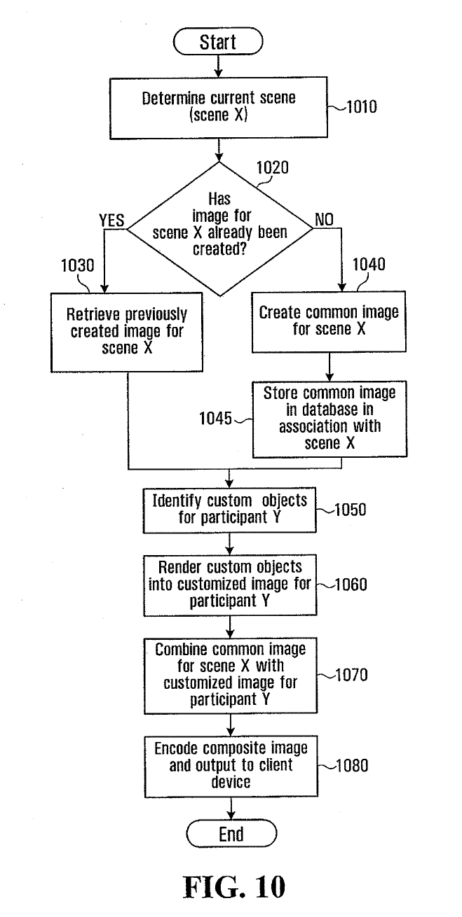

A second non-limiting example embodiment of the rendering control sub-routine 430 is now described with reference to FIG. 10.

At step 1010, the rendering control subroutine 430 determines the current scene for participant Y. As previously discussed, the current scene may refer to the section of the game world that is currently being perceived by participant Y. In one embodiment, the current scene may be a room in the game world as “seen” by a third-person virtual camera occupying a position in that room. In another embodiment, the current scene may be specified by a two-dimensional or three-dimensional position of participant Y's character together with a gaze angle and a field of view. By consulting the scene mapping database 700 (see FIG. 7), the server system 100 learns that, in this example, the current scene associated with participant Y is scene X.

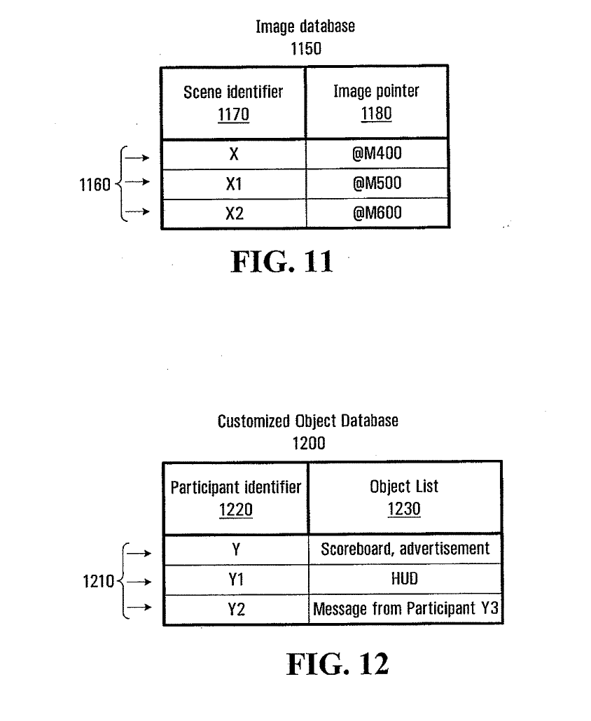

Having determined that participant Y is associated with scene X, the rendering control subroutine 430 proceeds to step 1020, whereby the server system 100 determines whether a common image for scene X has already been created. This may be achieved by consulting an image database. With reference to FIG. 11, there is shown an image database 1150, which is similar to the image database 800 in FIG. 8, except that there is no participant category field. To be precise, the image database 1150 includes a plurality of records 1160. Each record 1160 includes a scene identifier field 1170 and an image pointer field 1180. The records 1160 are accessed on the basis of a particular scene identifier so as to determine a corresponding image pointer. Specifically, the image pointer field 1180 includes a pointer which points to a location in memory that stores a rendered image for the particular scene identifier.

In the example image database 1150 of FIG. 11, images have been created for various scene identifiers. In particular, an image for scene identifier X is referenced by the pointer @M400, a image for scene identifier X1 is referenced by the pointer @M500, and an image for scene identifier X2 is referenced by the pointer @M600.

If the outcome of step 1020 is “yes”, the rendering control subroutine 430 proceeds to step 1030, by virtue of which a copy the common image associated with scene identifier X is retrieved. However, the first time that step 1020 is executed, the answer will be “no”. In other words, a common image for scene X will not yet have been rendered and it will be necessary to render it. In that case, the rendering control subroutine 430 proceeds to step 1040.

At step 1040, the rendering control subroutine 430 causes rendering of a common image for scene X, i.e., an image that would be visible to multiple participants sharing a view of scene X.

Accordingly, the rendering control subroutine 430 determines the objects in scene X. For example, a frustum can be applied to the game world, and the objects within than frustum are retained or marked. The frustum has an apex is situated at the location of participant Y (or the location of a camera associated with participant Y) and a directionality defined by the directionality of participant Y's gaze (or the directionality of the camera associated with participant Y).

Then, the objects in the scene X are rendered into a 2-D image for scene X. Rendering can be done for one or more objects within the game screen rendering range for scene X, depending on how many objects are being represented in the same image. After rasterization is performed, the data in the VRAM 109 will be representative of a two-dimensional image made up of pixels. Each pixel is associated with a color value, which can be an RGB value, a YCbCr value, and the like. In addition, the pixel may be associated with an alpha value, which varies between 0.0 and 1.0 and indicates a degree of transparency.

The rendering control subroutine 430 then proceeds to step 1045.

At step 1045, the rendered image is stored in memory and a pointer to the image (in this case, @M400) is stored in the image database 1150 in association with the identifier for scene X. As such, when the rendering control subroutine 430 is executed for another participant that is viewing scene X, the “yes” branch will be taken out of step 1020. This leads to step 1030, by virtue of which a copy of the previously generated image will be retrieved by referencing pointer @M400. Specifically, the pointer associated with scene identifier X can be obtained from the image database 1150, and then the image located at the memory location pointed to by the pointer can be retrieved. It will be noted that the previously generated image does not need to be re-rendered.

At step 1050, the rendering control subroutine 430 identifies a set of one or more customized objects for participant Y. Some of these objects may be 3-D objects, while others may be 2-D objects. In a non-limiting embodiment, the customized objects do not occupy a collision volume. This can mean that the customized objects do not take up space within the game world and might not even be part of the game world.

One non-limiting example of a customized object can be an object in the heads-up display (HUD), such as a fuel gauge, scoreboard, lap indicator, timer, list of available weapons, indicator of life left, etc.

Another non-limiting example of a customized object can be a message from the server system 100 of from another player. An example message could be a text message. Another example message could be a graphical message such as “hint” in the form of an arrow that points to a particular region in the scene where a trap door is located or where a villain (or other player) is about to emerge from. A talk bubble may include text from the server system 100.

A further non-limiting example of a customized object can be an advertisement, e.g., in the form of a banner or other object that can be overlaid onto or integrated with the common image for scene X.

Of course, it should be understood that rather than add a graphical element to what participant Y sees, a customized object could be rendered for the majority of the other participants in the game, so as to, for example, block their view. In this way, the lack of a customized object could be advantageous to participant Y vis-à-vis the other participants in the game, for whom the customized object appears on-screen.

Determining which objects will be in the set of customized object(s) for participant Y can be based on a number of factors, including factors in the business database 300 such as demographic data (age, gender, postal code, language, etc.). In some examples, the decision to provide hints or embellishments may be based on whether participant Y is a premium participant. In still other embodiments, the number of online followers may be used as a factor to determine which customized object should be made visible to participant Y.

The set of customized objects for a particular participant can be stored in a database, which may be stored in the storage medium 104 or elsewhere. For example, reference is made to FIG. 12, which shows a customized object list 1200 for a set of participants. The customized object list 1200 is conceptually illustrated as a table with a plurality of rows 1210, each of which has a participant identifier field 1220 and an object list field 1230. The participant identifier field 1220 stores an identifier of the participant, while the object list field 1230 for a particular participant stores a list of objects to be custom rendered for that participant.

By way of non-limiting example, FIG. 12 illustrates the case where the objects to be rendered for participant Y include a scoreboard and an advertisement. Additionally, the objects to be rendered specifically for participant Y1 include those in the heads-up-display (HUD), while the objects to be rendered for participant Y2 include a message from a participant denoted Y3.

At step 1060, the customized objects determined at step 1050 are rendered into one or more 2-D images. After rendering is performed, the data in the VRAM 109 will be representative of a two-dimensional customized image for participant Y. Each pixel in the customized image is associated with a color value, which can be an RGB value, a YCbCr value, and the like. In addition, the pixel may be associated with an alpha value, which varies between 0.0 and 1.0 and indicates a degree of transparency.

At this point, it will be appreciated that there are two images which will have been rendered, namely the common image for scene X rendered by virtue of step 1040 and the customized image for participant Y rendered by virtue of step 1060. The rendering control subroutine 430 then proceeds to step 1070.

At step 1070, the two images are combined into a single composite image for participant Y.

In a non-limiting example embodiment, which would work particularly well for GUI elements or text or other customized elements that are overlaid onto the common image for scene X, combining can be achieved by alpha compositing, also known as alpha blending. Alpha blending refers to a convex combination of two colors allowing for transparency effects. Thus, for a given pixel having an RGBA value in the image for scene X and having a second RGBA value in the image customized for participant Y, the RGB (color) values can be blended in accordance with the respective A (alpha) values. The alpha value can itself provide a further degree of customization for participant Y.

Having created the composite image for participant Y, the rendering control subroutine 430 terminates and the video game program proceeds to step 440, which has been previously described.

### Alternative Embodiment of Game Screen Creation by Main Game Loop

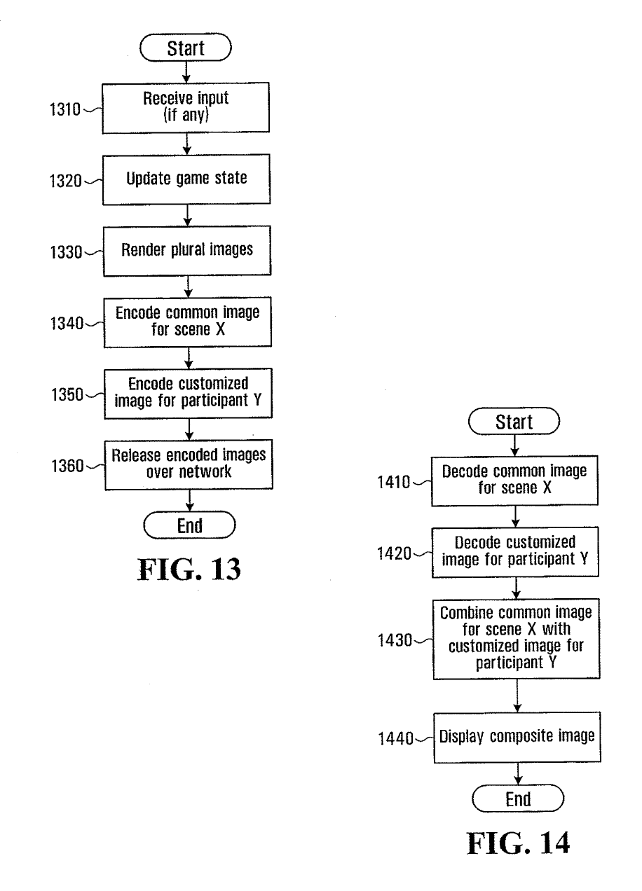

Reference is now made to FIG. 13, which conceptually illustrates the steps in a main processing loop (or main game loop) of the video game program implemented by the server system 100, in accordance with an alternative embodiment of the present invention. The main game loop may include steps 1310 to 1360, which are described below in further detail.

Steps 1310 and 1320 are identical to steps 410 and 420 of the man game loop, which were previously described with reference to FIG. 4.

For its part, step 1330 represents a rendering control subroutine. In particular, the rendering control subroutine 1330 includes steps 1010 through 1060 that were previously described with reference to FIG. 10. As such, the rendering control subroutine 1330 creates two images, namely a common image for scene X rendered by virtue of step 1040 and a customized image for participant Y rendered by virtue of step 1060. However, rather than combining these images at step 1070, this step is omitted from the rendering control subroutine 1330, and the main game loop proceeds to step 1340.

At step 1340, the common image for scene X is encoded, while the customized image for participant Y is encoded at step 1350. Encoding may be done in accordance with any one of a plurality of standard encoding and compression techniques, such as H.263 and H.264. The same or different encoding processes may be used for the two images. Of course, steps 1340 and 1350 can be performed in any order or contemporaneously.

At step 1360, the encoded images are released towards participant Y's client device. The encoded images travel over the network 14 and arrive at participant Y's client device.

FIG. 14 shows steps 1410, 1420, 1430 and 1440, which can be executed at the client device further to receipt of the encoded images sent at step 1360.

Specifically, at step 1410, the client device decodes the image for scene X, while at step 1420, the client device decodes the customized media stream for participant Y. At step 1430, the client device combines the image for scene X with the customized image for participant Y into a composite image. In a non-limiting example embodiment, this can be achieved by alpha blending, as was previously described in the context of step 1070. The alpha value for the pixels in the image for scene X and/or the customized image for participant Y can be further modified at the client device for additional customization. The composite image is then displayed on the client device at step 1440.

In a variant, more than two common images for scene X may be produced and combined with the customized image for participant Y. The more than two common images may represent different respective subsets of objects common to scene X. For example, there may be a plurality of common images pertaining to different layers of scene X.

In another variant, more than two customized images for participant Y may be produced and combined with the common image for scene X. For example, there may be a plurality of customized images, each representing one or more customized objects for participant Y.

In a further variant, a local customized image can be generated by the client device itself, and then combined with the image for scene X and possibly also with the customized image for participant Y received from the server system 100. In this way, information that is customized for participant Y and maintained at the client device can be used to further customize the game screen that is viewed by participant Y, yet at least one image for scene X is still commonly generated for all participants who are viewing that scene.

While the above example has focused on 2-D images, the present invention does not exclude the possibility of storing 3-D images or stereoscopic images. In addition, audio information or other ancillary information may be associated with the image and stored in the VRAM 109 or elsewhere (e.g., the storage medium 104 or the local memory 103). In particular, it is within the scope of the invention to generate an audio segment that is shared by more than one participant category, and to complement this common audio segment with individual audio segments that are customized for each participant category.

Persons skilled in the art should appreciate that the above discussed embodiments are to be considered illustrative and not restrictive. Also it should be appreciated that additional elements that may be needed for operation of certain embodiments of the present invention have not been described or illustrated as they are assumed to be within the purview of the person of ordinary skill in the art. Moreover, certain embodiments of the present invention may be free of, may lack and/or may function without any element that is not specifically disclosed herein.

Those skilled in the art will also appreciate that additional adaptations and modifications of the described embodiments can be made. The scope of the invention, therefore, is not to be limited by the above description of specific embodiments but rather is defined by the claims attached hereto.

1. A method for creating and sending video game images, comprising:
identifying a scene being viewed by a participant in a video game;
determining whether there exists a previously created image corresponding to the scene and corresponding to a participant category to which the participant belongs;
in response to the determining being positive, retrieving the previously created image and releasing the retrieved image towards a device associated with the participant;
in response to the determining being negative, rendering an image corresponding to the scene and corresponding to the participant category, and releasing the rendered image towards a device associated with the participant.

2. The method defined in claim 1, wherein identifying the scene comprises identifying one of a plurality of fixed virtual cameras in the video game.

3. The method defined in claim 1, wherein identifying the scene comprises identifying a position, direction and field of view associated with a character controlled by the participant.

4. The method defined in claim 1, wherein determining whether there exists a previously created image corresponding to the scene and corresponding to the participant category to which the participant belongs comprises consulting a database on the basis of an identifier of the scene and an identifier of the participant category.

5. The method defined in claim 1, wherein rendering the image corresponding to the scene and corresponding to the participant category comprises identifying a plurality of objects associated with the scene and customizing at least one of the objects in accordance with the participant category.

6. The method defined in claim 5, wherein customizing a given one of the objects in accordance with the participant category comprises determining an object property associated with the participant category and applying the object property to the given one of the objects.

7. The method defined in claim 6, wherein the object property associated with the participant category comprises a texture uniquely associated with the participant category.

8. The method defined in claim 6, wherein the object property associated with the participant category comprises a shading function uniquely associated with the participant category.

9. The method defined in claim 6, wherein the object property associated with the participant category comprises a color uniquely associated with the participant category.

10. The method defined in claim 6, further comprising determining the participant category to which the participant belongs and looking up the object property in a database on the basis of the participant category.

11. The method defined in claim 1, further comprising obtaining an identifier of the participant, wherein determining the participant category comprises consulting a database on the basis of the identifier of the participant.

12. The method defined in claim 1, wherein retrieving the previously created image comprises consulting a database on the basis of the participant category and the scene.

13. The method defined in claim 12, wherein subsequent to creating an image, the method further comprises storing the created image in the database in association with the participant category and the scene.

14. The method defined in claim 1, further comprising encoding the image prior to the releasing.

15. The method defined in claim 1, wherein the participant category is one of a plurality of participant categories corresponding to different respective population groups.

16. The method defined in claim 1, wherein the participant category is one of a plurality of participant categories corresponding to different respective languages.

17. The method defined in claim 1, wherein the participant category is one of a plurality of participant categories corresponding to different respective geographic regions.

18. The method defined in claim 1, wherein the participant category is one of a plurality of participant categories corresponding to different respective local laws.

19. The method defined in claim 1, wherein the participant category is one of a plurality of participant categories corresponding to different respective age groups.

20. The method defined in claim 1, wherein the participant category is one of a plurality of participant categories corresponding to different respective levels of gameplay experience.

21. A non-transitory computer-readable medium storing instructions for execution by at least one processor of a computing device, wherein execution of the instructions by the at least one processor of the computing device causes the computing device to implement a method for creating and sending video game images, comprising:
identifying a scene being viewed by a participant in a video game;
determining whether there exists a previously created image corresponding to the scene and corresponding to a participant category to which the participant belongs;
in response to the determining being positive, retrieving the previously created image and releasing the retrieved image towards a device associated with the participant;
in response to the determining being negative, rendering an image corresponding to the scene and corresponding to the participant category, and releasing the rendered image towards a device associated with the participant.

22. A method of rendering a scene in a video game, comprising:
identifying a set of objects to be rendered; and
rendering the set of objects into a plurality of different images for the same scene, the different images being associated with different groups of participants.

23. The method defined in claim 22, wherein rendering the set of objects into a plurality of different images for the same scene comprises rendering the set of objects into a first image associated with a first participant category and a second image associated with a second participant category.

24. The method defined in claim 23, wherein rendering the set of objects into the first image associated with the first participant category comprises customizing at least one of the objects in accordance with the first participant category and wherein rendering the set of objects into the second image associated with the second participant category comprises customizing the at least one of the objects in accordance with the second participant category.

25. The method defined in claim 24, wherein customizing the given one of the objects in accordance with the first participant category comprises determining a first object property associated with the first participant category and applying the first object property to the given one of the objects, and wherein customizing the given one of the objects in accordance with the second participant category comprises determining a second object property associated with the second participant category and applying the second object property to the given one of the objects.

26. The method defined in claim 25, wherein the first object property associated with the first participant category comprises a texture uniquely associated with the first participant category and wherein the second object property associated with the second participant category comprises a texture uniquely associated with the second participant category.

27. The method defined in claim 25, wherein the first object property associated with the first participant category comprises a shading function uniquely associated with the first participant category and wherein the second object property associated with the second participant category comprises a shading function uniquely associated with the second participant category.

28. The method defined in claim 25, wherein the first object property associated with the first participant category comprises a color uniquely associated with the first participant category and wherein the second object property associated with the second participant category comprises a color uniquely associated with the second participant category.

29. The method defined in claim 22, wherein the different groups of participants correspond to different respective languages.

30. The method defined in claim 22, wherein the different groups of participants correspond to different respective geographic regions.

31. The method defined in claim 22, wherein the different groups of participants correspond to different respective local laws.

32. The method defined in claim 22, wherein the different groups of participants correspond to different respective age groups.

33. The method defined in claim 22, wherein the different groups of participants correspond to different respective levels of gameplay experience.

34. A non-transitory computer-readable medium storing instructions for execution by at least one processor of a computing device, wherein execution of the instructions by the at least one processor of the computing device causes the computing device to implement a method for rendering a scene in a video game, comprising:
identifying a set of objects to be rendered; and
rendering the set of objects into a plurality of different images for the same scene, the different images being associated with different groups of participants.

35. A method for transmitting video game images, comprising:
sending a first image of a video game scene to a plurality of participants in a first participant category, the first image being customized for the first participant category; and
sending a second image of the same video game scene to a plurality of participants in a second participant category, the second image being customized for the second participant category, the first and second images being different images of the same video game scene.

36. The method defined in claim 35, wherein the first image is rendered once for a particular one of the participants in the first participant category and thereafter copies of the rendered first image are distributed to other ones of the participants in the first participant category.

37. The method defined in claim 35, wherein to render the first image, the method comprises:
identifying a plurality of objects common to the scene;
identifying a plurality of first objects common to the first participant category;
rendering the objects common to the scene and the first objects into the first image.

38. The method defined in claim 35, wherein the second image is rendered once for a particular one of the participants in the second participant category and thereafter copies of the rendered second image are distributed to other ones of the participants in the second participant category.

39. The method defined in claim 35,
wherein to render the second image, the method comprises:
identifying a plurality of second objects common to the second participant category;
rendering the objects common to the scene and the second objects into the second image.

40. The method defined in claim 35, wherein the first and second participant categories correspond to different respective languages.

41. The method defined in claim 35, wherein the first and second participant categories correspond to different respective geographic regions.

42. The method defined in claim 35, wherein the first and second participant categories correspond to different respective local laws.

43. The method defined in claim 35, wherein the first and second participant categories correspond to different respective age groups.

44. The method defined in claim 35, wherein the first and second participant categories correspond to different respective levels of gameplay experience.

45. The method defined in claim 36, further comprising storing the first image in the memory in association with the scene and the first participant category, wherein the copies of the first image are retrieved from the memory.

46. The method defined in claim 38, further comprising storing the first image in the memory in association with the scene and the first participant category, wherein the copies of the first image are retrieved from the memory.

47. The method defined in claim 35, further comprising:
encoding the first image prior to sending; and
encoding the second image prior to sending.

48. A non-transitory computer-readable medium storing instructions for execution by at least one processor of a computing device, wherein execution of the instructions by the at least one processor of the computing device causes the computing device to implement a method for video game image distribution, comprising:
sending a first image of a video game scene to a plurality of participants in a first participant category, the first image being customized for the first participant category; and
sending a second image of the same video game scene to a plurality of participants in a second participant category, the second image being customized for the second participant category, the first and second images being different images of the same video game scene.

49. A method for control of video game rendering, comprising:
identifying a scene being viewed by a participant in a video game;
obtaining an image for the scene;
rendering at least one customized image for the participant;
combining the image for the scene and the at least one customized image for the participant, thereby to create a composite image for the participant.

50. The method defined in claim 49, further comprising:
determining whether there exists in memory a previously created image for the scene;
wherein when the response to the determining is positive, the obtaining comprises retrieving the previously created image from the memory;
wherein when the response to the determining is negative, the obtaining comprises rendering an image corresponding to the scene.

51. The method defined in claim 49, wherein rendering the at least one customized image for the participant comprises identifying at least one object to be rendered and rendering the at least one object.

52. The method defined in claim 51, wherein appearance of the at least one object in the customized image for the participant provides the participant with a playing advantage over other participants for which the at least one object is not rendered.

53. The method defined in claim 51, wherein appearance of the at least one object in the customized image for the participant provides the participant with a playing disadvantage over other participants for which the at least one object is not rendered.

54. The method defined in claim 51, wherein appearance of the at least one object in the customized image for the participant provides the participant with occluded vision.

55. The method defined in claim 51, wherein the at least one object comprises an object that is represented in the customized image for the participant and in no other customized image for any other participant.

56. The method defined in claim 51, wherein the at least one object is part of a heads-up display (HUD).

57. The method defined in claim 51, wherein the at least one object comprises a message from another player.

58. The method defined in claim 51, implemented by a server system, wherein the at least one object comprises a message from the server system.

59. The method defined in claim 51, wherein the at least one object comprises an advertisement.

60. The method defined in claim 51, further comprising selecting the at least one object based on demographic information about the participant.

61. The method defined in claim 51, further comprising selecting the at least one object based on whether the participant is a premium subscriber to the video game.

62. The method defined in claim 49, wherein identifying the scene comprises identifying one of a plurality of fixed virtual cameras in the video game.

63. The method defined in claim 49, wherein identifying the scene comprises identifying a position, direction and field of view associated with a character controlled by the participant.

64. The method defined in claim 49, further comprising releasing the composite image towards a device associated with the participant.

65. The method defined in claim 49, wherein the combining comprises alpha blending the image for the scene and the customized image for the participant.

66. The method defined in claim 49, the participant being a first participant, the composite image being a first composite image, wherein the scene is also being viewed by a second participant in the video game, and wherein the method further comprises:
rendering at least one second customized image for the second participant;
combining the image for the scene and the at least one second customized image for the second participant, thereby to create a second composite image for the second participant.

67. The method defined in claim 66, wherein rendering the at least one second customized image for the second participant comprises identifying at least one second object to be rendered and rendering the at least one second object.

68. The method defined in claim 67, wherein the at least one second object comprises an object that is represented in the second customized image for the second participant and not in the first customized image for the first participant.

69. The method defined in claim 66, further comprising releasing the second composite image towards a device associated with the second participant.

70. A non-transitory computer-readable medium storing instructions for execution by at least one processor of a computing device, wherein execution of the instructions by the at least one processor of the computing device causes the computing device to implement a method for control of video game rendering, the method comprising:
identifying a scene being viewed by a participant in a video game;
obtaining an image for the scene;
rendering at least one customized image for the participant;
combining the image for the scene and the at least one customized image for the participant, thereby to create a composite image for the participant.

71. A method for control of video game rendering, comprising:
identifying a scene being viewed by a participant in a video game;
determining whether an image for the scene has been previously rendered;
in response to the determining being positive, retrieving the image for the scene, otherwise rendering the image for the scene;
rendering at least one customized image for the participant;
sending to the participant the image for the scene and the at least one customized image for the participant.

72. The method defined in claim 71, wherein identifying the scene comprises identifying one of a plurality of fixed virtual cameras in the video game.

73. The method defined in claim 71, wherein identifying the scene comprises identifying a position, direction and field of view associated with a character controlled by the participant.

74. The method defined in claim 71, wherein retrieving the image for the scene comprises consulting a database on the basis of an identifier of the scene.

75. The method defined in claim 74, wherein subsequent to rendering the image for the scene, the method further comprises storing the rendered image in the database in association with the identifier of scene.

76. The method defined in claim 71, further comprising encoding the image for the scene and the at least one customized image prior to the sending.

77. The method defined in claim 71, wherein rendering the at least one customized image for the participant comprises identifying at least one object to be rendered and rendering the at least one object.

78. The method defined in claim 77, wherein representing the at least one object in the customized image for the participant provides the participant with a playing advantage over other participants for which the at least one object is not rendered.

79. The method defined in claim 77, wherein representing the at least one object in the customized image for the participant provides the participant with a playing disadvantage over other participants for which the at least one object is not rendered.

80. The method defined in claim 77, wherein representing the at least one object in the customized image for the participant provides the participant with occluded vision.

81. The method defined in claim 77, wherein the at least one object comprises an object that is represented in the customized image for the participant and in no other customized image for any other participant.

82. The method defined in claim 77, wherein the at least one object is part of a heads-up display (HUD).

83. The method defined in claim 77, wherein the at least one object comprises a message from another player.

84. The method defined in claim 77, implemented by a server system, wherein the at least one object is a message from the server system.

85. The method defined in claim 77, wherein the at least one object comprises an advertisement.

86. The method defined in claim 77, further comprising selecting the at least one object based on demographic information about the participant.

87. The method defined in claim 77, further comprising selecting the at least one object based on whether the participant is a premium subscriber to the video game.

88. The method defined in claim 71, wherein rendering the at least one customized image for the participant comprises identifying a plurality of sets of objects to be rendered and rendering each set of objects into a separate customized image for the participant.

89. A non-transitory computer-readable medium storing instructions for execution by at least one processor of a computing device, wherein execution of the instructions by the at least one processor of the computing device causes the computing device to implement a method for control of video game rendering, comprising:
identifying a scene being viewed by a participant in a video game;
determining whether an image for the scene has been previously rendered;
in response to the determining being positive, retrieving the image for the scene, otherwise rendering the image for the scene;
rendering at least one customized image for the participant;
sending to the participant the image for the scene and the at least one customized image for the participant.

90. A method for control of game screen rendering at a client device associated with a participant in a video game, comprising:
receiving a first image common to a group of participants viewing a same scene in a video game;
receiving a second image customized for the participant;
combining the first and second images into a composite image; and
displaying the composite image on the client device.

91. The method defined in claim 90, wherein combining the first and second images into the composite image comprises alpha blending of the first and second images.

92. The method defined in claim 90, wherein the first and second images are encoded, the method further comprising decoding the first and second images before combining them into the composite image.

93. The method defined in claim 90, the scene being derived from a selection made by a user of the client device, the method further comprising transmitting a signal to a server system, the signal indicative of the selection made by the user.

94. A mobile communication device configured for implementing the method of claim 90.

95. A non-transitory computer-readable medium storing instructions for execution by at least one processor of a computing device, wherein execution of the instructions by the at least one processor of the computing device causes the computing device to implement a method for control of game screen rendering at a client device associated with a participant in a video game, the method comprising:
receiving a first image common to a group of participants viewing a same scene in a video game;
receiving a second image customized for the participant;
combining the first and second images into a composite image; and
displaying the composite image on the client device.
